(19) United States
(12) Patent Application Publication
(10) Pub. No.: US 2003/0175075 A1
(43) Pub. Date: Sep. 18, 2003

(54) Dovetail with locking teeth

(76) Inventor: Arthur L. Garrison, Rogers, AR (US)

Correspondence Address: ARTHUR L. GARRISON, 20410 LAKEVIEW DR., ROGERS, AR, 72756, US

(21) Appl. No.: 10/098,063

(22) Filed: Mar. 15, 2002

(51) Int. Cl. B25G 3/08

(52) U.S. Cl. 403/381

(57) ABSTRACT

A dovetail positioning device including a fixed base member with teeth in at least one angular dovetail surface a moveable member with dovetail cross section of shape and size to interfit with the fixed base a clamping means to force the teeth of the fixed and moveable members to mesh thus establishing a repeatable position in three planes.

### BACKGROUND

1. Field of Invention

This invention relates to a dovetail with locking teeth, specifically to a dovetail for locking positioning elements together in three axis.

2. Description of Prior Art

Development of CNC (computer numerical control) machines has brought new capabilities, and new needs, to the machine industry. CNC machines have the ability to perform programmable tasks with predictable precision and repeatability.

Because CNC machines are very expensive, in order to cost justify them, the cutter must remain in the work piece as much as possible. Likewise the spindle must remain idle as little as possible. To this end, the so called “set up time”, more recently referred to as “changeover time”, must be held to a minimum. The old method of clamping parts or vises to a machine table, indicating them in, and finding their location relative to the machine coordinates is just too time consuming. What is needed is the ability to locate work pieces relative to machine coordinates with the same precision and repeatability as the CNC machine.

There is a family of devices that address this need. They are referred to as “pallet systems”. In general, pallet systems are very complex and accordingly, very expensive.

Existing pallet systems are not only complex, their thickness, (dimension in the vertical or “Z” axis) is a problem. The thickness reduces the clearance between tools in the tool changer and the work piece. Most manufacturers of pallet systems do not recommend them, unless the machine has an extended “Z” axis to allow for this thickness.

U.S. Pat. No. 5,346,051 Sep. 13, 1994 to: Malcolm E. Keith of West Chicago, Ill. Assigned to: Midaco corporation of Elk Grove, Ill. Reveals an example using pins and bushing to locate, with spring loaded pin retainers or clamps to retain the pins in the bushings. This is an example of the complexity and thickness of a pallet changer.

U.S. Pat. No. 4,489,924 to: Thomas F. McDougal, 1415 Beech Ln. Fairmont, W. Va. discloses a hydraulically actuated clamping table assembly. This also is an example of the complexity and thickness of existing pallet systems. This system does make use of a dovetail for positioning, but the dovetail offers no positive “locked” position.

Dovetails in the machine industry are very well known. Dovetails locate very well in two planes. Dovetails are generally used for sliding members. Known dovetails when clamped to hold mating members in relative position are susceptible to slippage or skidding when subjected to a force parallel to their primary axis. Known dovetails have no ability to “lock” into a repeatable position.

### OBJECTS AND ADVANTAGES

Several objects and advantages of the present invention are:

a) Simplicity of design, allowing for more economical manufacture.

b) Very low profile, providing more tool clearance.

c) Simple, quick changeover.

d) No need for complex control systems that must “tie in” to the machine control.

e) Solid, positive locking in three axis.

f) Predictable, repeatable precision positioning.

g) Reduced need for high clamping forces.

Although well suited to machine tool pallet changers, the present invention is by no means limited to this embodiment. The dovetail with locking teeth is ideal in a variety of embodiments. One such embodiment would be the affixing of assembly bases for appliances or other assembly operations requiring a solid mounting for hand operations.

Another embodiment would be for positive positioning on automated assembly lines. A further embodiment would be used in vise jaws to positively position vise pallets, or other objects with mating teeth. Another embodiment would be fixtures or parts that have mating teeth machined into them. This is by no means an extensive list of possible embodiments. Further objects and advantages will become apparent from the following description and drawings.

### DRAWING FIGURES

FIG. 1 Shows an oblique drawing of a typical assembly, with locking dovetail teeth and clamp.

FIG. 2 Shows a top view and cross section, with clamp and clamping screw.

FIG. 3 Shows a top view and cross section with a clamping screw.

### REFERENCE NUMERALS IN DRAWINGS

10 Base element with teeth

12 Removable element with mating teeth

14 Clamping element

16 Clamping screw

18 Teeth

20 Mating teeth

### SUMMARY

In accordance with the present invention, dovetail with locking teeth, a base element with teeth, a moveable element with mating teeth, and a means for clamping the elements together.

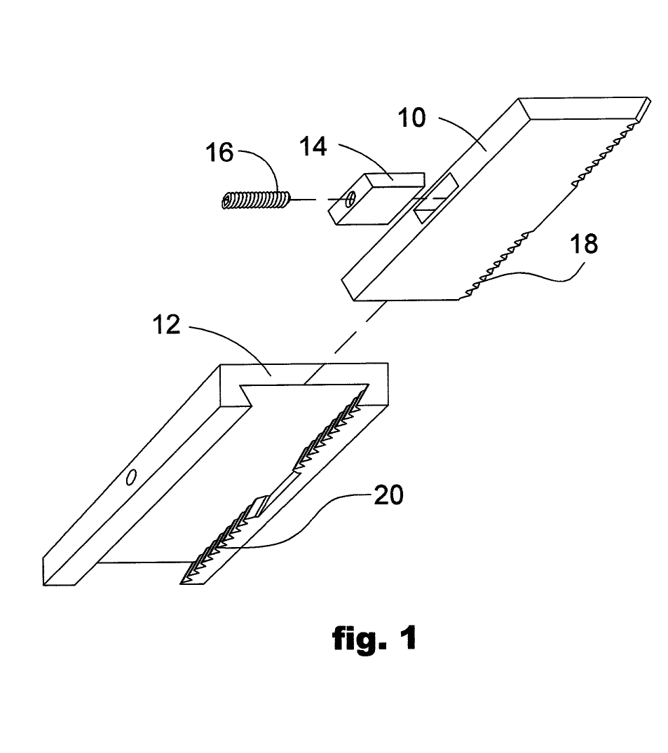

### Description FIGS. 1 through 3

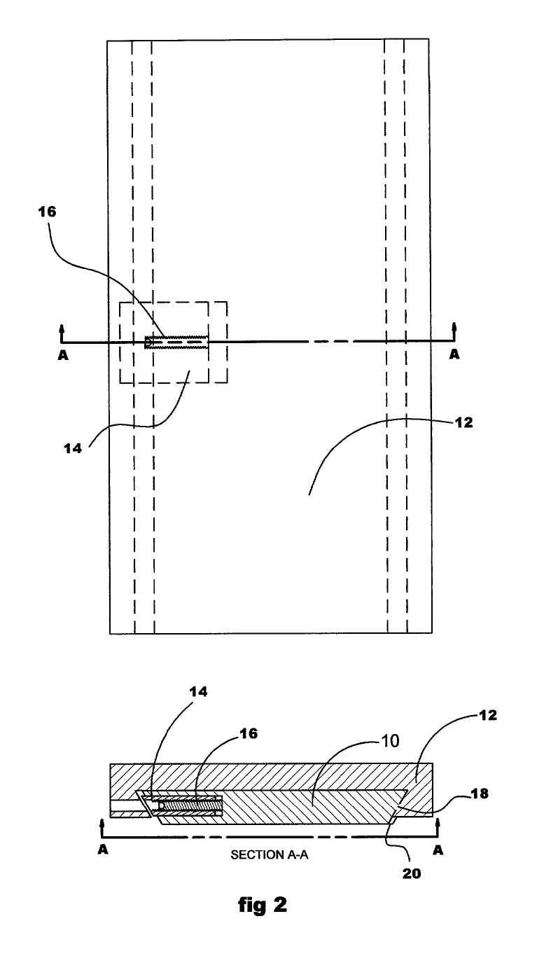

According to the preferred embodiment of the present invention as shown in FIGS. 1 and 2, A base element 10 is fastened in a fixed position. A removable element 12 with mating dovetail is mated to base 10. Clamping element 14 is forcibly moved by clamping screw 16, engaging mating teeth 18 and 20 forcibly locking elements 10 and 12 together.

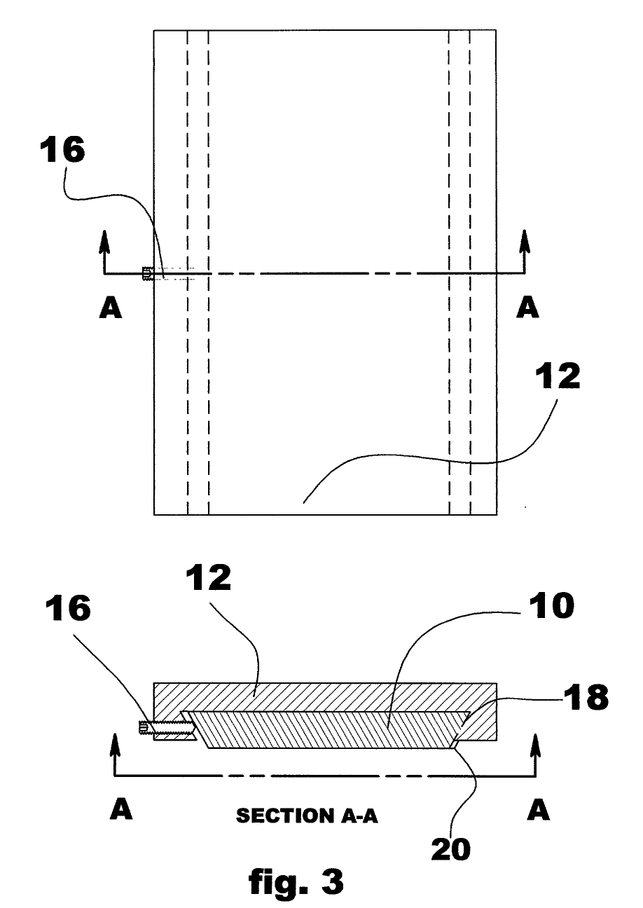

An additional embodiment is shown in FIG. 3 In this embodiment the clamping screw 16 forcibly acts directly on the dovetail of base 10 engaging mating teeth 18 and 20, forcibly locking base elements 10 and 12 together.

Various possibilities exist for different embodiments, especially in the method of clamping. Fluid power clamping is a possible embodiment. Cam driven clamping is a possible embodiment. Robotic or remotely actuated clamping is a possible embodiment. A machine vise with teeth in the vise jaws is a possible embodiment.

### Operation—FIGS. 1 through 3

In the operation of the preferred embodiment, used as a pallet changer, the base element 10 is fastened to a machine table. The machine operator fastens parts or fixtures to the removable element 12, (the “pallet”). Removable element 12 is positioned on base 10, clamping screw 16 is tightened forcing clamping element 14 against the dovetail of moveable element 12 engaging the mating teeth and clamping elements 10 and 12 together in a fixed position. Typically, two pallets are used allowing the machine operator to load one pallet while the other is in the machine.

### CONCLUSIONS, RAMIFICATIONS, AND SCOPE

Accordingly the reader will see that the dovetail with locking teeth can be used in a variety of embodiments and applications. The simplicity of the invention allows for broad usage. Furthermore, the dovetail with locking teeth has additional advantages in that:

A. it can be configured in a very compact arrangement, even what could be considered miniature size, and still maintain great holding power in three planes.

B. By adding a third plane to a clamping operation, much lower clamping forces are required for stable positioning.

C. With the ability to clamp reliably with low clamping forces it can be applied to fragile elements.

Although the description above contains many specifics, these should not be construed as limiting the scope of the invention but as merely providing illustrations of some of the presently preferred embodiments of the invention. Thus the scope of the invention should be determined by the appended claims and their legal equivalents, rather than by the examples given.

I claim:

1. A dovetail with locking teeth comprising a rigid base member of dovetail cross section having teeth on an angular dovetail surface a moveable member of dovetail cross section having teeth on an angular dovetail surface said moveable member shaped and sized to interfit with said base member a clamping means to slideably force said teeth of said base member to mesh with said teeth of said moveable member whereby said fixed and moveable members may be locked together giving repeatable positioning in three axis.
